(19) United States
(12) Patent Application Publication
(10) Pub. No.: US 2025/0159522 A1
(43) Pub. Date: May 15, 2025

(54) CONFIGURATION INFORMATION FOR NON-SERVING CELL REFERENCE SIGNAL REPORTING

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US); Fang YUAN, Beijing (CN)

(21) Appl. No.: 18/730,087

(22) PCT Filed: Mar. 14, 2022
(86) PCT No.: PCT/CN2022/080564

§ 371 Date: Jul. 18, 2024

(51) Int. Cl. H04W 24/10; H04B 7/06; H04B 17/318

(52) U.S. Cl. CPC H04W 24/10; H04B 7/0626; H04B 17/328

(57) ABSTRACT

A user equipment (UE) and a network entity may communicate to identify characteristics of a network and/or link that the UE and the network entity can use for communication. However, the UE may lack information indicating which reference signals the UE is to measure and which reference signals the UE can forgo measuring to reduce power consumption, network traffic, or message overhead, among other examples. Some aspects described herein enable a network entity to provide a UE with configuration information to enable the UE to perform event-driven reporting. For example, a network entity may provide a UE with codebook information or location information with which the UE can identify which non-serving cells, of a plurality of available non-serving cells, the UE is to measure and report on. In this way, the network entity and the UE enable reduced power consumption, network traffic, or message overhead.

### FIELD OF THE DISCLOSURE

Aspects of the present disclosure generally relate to wireless communication and to techniques and apparatuses for configuration information for non-serving cell reference signal reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G, 5G, and other radio access technologies remain useful.

### SUMMARY

A user equipment (UE) and a network entity may communicate to identify characteristics of a network and/or link that the UE and the network entity can use for communication. For example, a UE may perform a measurement of a reference signal and may report the measurement to the network entity. The network entity may use the report of the measurement of the reference signal to select a beam for use in communication with the UE. Additionally, or alternatively, the network entity may use the report for configuring cells, other network entities, handovers, and/or other procedures within the network. Event-driven reporting may enable a reduction in a quantity of beam measurements and/or reports of beam measurements, which may reduce network congestion or message overhead, among other examples. For example, a UE may determine to perform measurements of a subset of cells that are configured for the UE, rather than all cells that are configured for the UE, based at least in part on an event. One example of an event is that the UE may use a single serving cell reference signal received power (RSRP) threshold to trigger a report of one or more measurements. However, the UE may lack information indicating which reference signals the UE is to measure and which reference signals the UE can forgo measuring to reduce power consumption, network traffic, or message overhead, among other examples.

Some aspects described herein enable a network entity to provide a UE with configuration information to enable the UE to perform event-driven reporting. For example, a network entity may provide a UE with codebook information or location information with which the UE can identify which non-serving cells, of a plurality of available non-serving cells, the UE is to measure and report on. In this case, the UE may use the configuration information to identify resources for measuring non-serving cell reference signals, measure the non-serving cell reference signals, and transmit reports regarding the non-serving cell reference signals. In this way, the network entity and the UE enable reduced power consumption, network traffic, or message overhead relative to attempting to perform event-driven reporting without the aforementioned configuration information.

Some aspects described herein relate to a method of wireless communication performed by a UE. The method may include receiving configuration information identifying reference signal information for one or more non-serving cells, wherein the reference signal information includes codebook information or antenna location information for a reference signal. The method may include reporting a beam measurement associated with the reference signal based at least in part on the codebook information or the antenna location information for the reference signal.

Some aspects described herein relate to a method of wireless communication performed by a network entity. The method may include transmitting configuration information identifying reference signal information for one or more non-serving cells, wherein the reference signal information includes codebook information or antenna location information for a reference signal. The method may include receiving a report of a beam measurement, associated with the reference signal, in accordance with the codebook information or the antenna location information for the reference signal.

Some aspects described herein relate to a UE for wireless communication. The user equipment may include a memory and one or more processors coupled to the memory. The one or more processors may be configured to receive configuration information identifying reference signal information for one or more non-serving cells, wherein the reference signal information includes codebook information or antenna location information for a reference signal. The one or more processors may be configured to report a beam measurement associated with the reference signal based at least in part on the codebook information or the antenna location information for the reference signal.

Some aspects described herein relate to a network entity for wireless communication. The network entity may include a memory and one or more processors coupled to the memory. The one or more processors may be configured to transmit configuration information identifying reference signal information for one or more non-serving cells, wherein the reference signal information includes codebook information or antenna location information for a reference signal. The one or more processors may be configured to receive a report of a beam measurement, associated with the reference signal, in accordance with the codebook information or the antenna location information for the reference signal.

Some aspects described herein relate to a non-transitory computer-readable medium that stores a set of instructions for wireless communication by a UE. The set of instructions, when executed by one or more processors of the UE, may cause the UE to receive configuration information identifying reference signal information for one or more non-serving cells, wherein the reference signal information includes codebook information or antenna location information for a reference signal. The set of instructions, when executed by one or more processors of the UE, may cause the UE to report a beam measurement associated with the reference signal based at least in part on the codebook information or the antenna location information for the reference signal.

Some aspects described herein relate to a non-transitory computer-readable medium that stores a set of instructions for wireless communication by a network entity. The set of instructions, when executed by one or more processors of the network entity, may cause the network entity to transmit configuration information identifying reference signal information for one or more non-serving cells, wherein the reference signal information includes codebook information or antenna location information for a reference signal. The set of instructions, when executed by one or more processors of the network entity, may cause the network entity to receive a report of a beam measurement, associated with the reference signal, in accordance with the codebook information or the antenna location information for the reference signal.

Some aspects described herein relate to an apparatus for wireless communication. The apparatus may include means for receiving configuration information identifying reference signal information for one or more non-serving cells, wherein the reference signal information includes codebook information or antenna location information for a reference signal. The apparatus may include means for reporting a beam measurement associated with the reference signal based at least in part on the codebook information or the antenna location information for the reference signal.

Some aspects described herein relate to an apparatus for wireless communication. The apparatus may include means for transmitting configuration information identifying reference signal information for one or more non-serving cells, wherein the reference signal information includes codebook information or antenna location information for a reference signal. The apparatus may include means for receiving a report of a beam measurement, associated with the reference signal, in accordance with the codebook information or the antenna location information for the reference signal.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is diagram illustrating an example of a wireless network.

FIG. 2 is a diagram illustrating an example of a base station in communication with a user equipment (UE) in a wireless network.

FIG. 3 is a diagram illustrating an example of an open radio access network (RAN) (O-RAN) architecture.

FIG. 4 is a diagram illustrating an example of channel state information (CSI) reference signal (RS) (CSI-RS) beam management procedures.

FIG. 5 is a diagram illustrating an example of physical channels and reference signals in a wireless network.

FIGS. 6A-6B are diagrams illustrating examples associated with configuring non-serving cell reference signal reporting.

FIGS. 7-8 are flowcharts of example methods of wireless communication.

FIG. 9 is a diagram of an example apparatus for wireless communication.

FIG. 10 is a diagram illustrating an example of a hardware implementation for an apparatus employing a processing system.

FIG. 11 is a diagram of an example apparatus for wireless communication.

FIG. 12 is a diagram illustrating an example of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

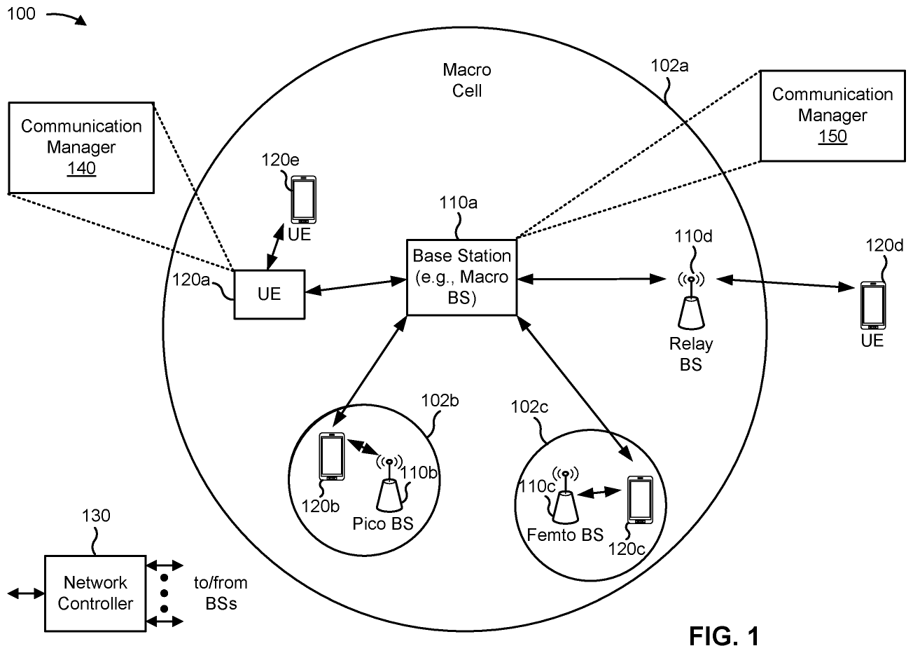

FIG. 1 is a diagram illustrating a wireless network 100 in which aspects of the present disclosure may be practiced. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, a 5G base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G, two initial operating bands have been identified as frequency range designations FR1 (410 MHz-7.125 GHZ) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information identifying reference signal information for one or more non-serving cells, wherein the reference signal information includes codebook information or antenna location information for a reference signal; and report a beam measurement associated with the reference signal based at least in part on the codebook information or the antenna location information for the reference signal. Additionally, or alternatively, the communication manager 140 may perform one or more other operations described herein.

In some aspects, a network entity, such as a base station 110, may include a communication manager 150. As described in more detail elsewhere herein, the communication manager 150 may transmit configuration information identifying reference signal information for one or more non-serving cells, wherein the reference signal information includes codebook information or antenna location information for a reference signal; and receive a report of a beam measurement, associated with the reference signal, in accordance with the codebook information or the antenna location information for the reference signal. Additionally, or alternatively, the communication manager 150 may perform one or more other operations described herein.

As indicated above, FIG. 1 is provided as an example. Other examples may differ from what is described with regard to FIG. 1.

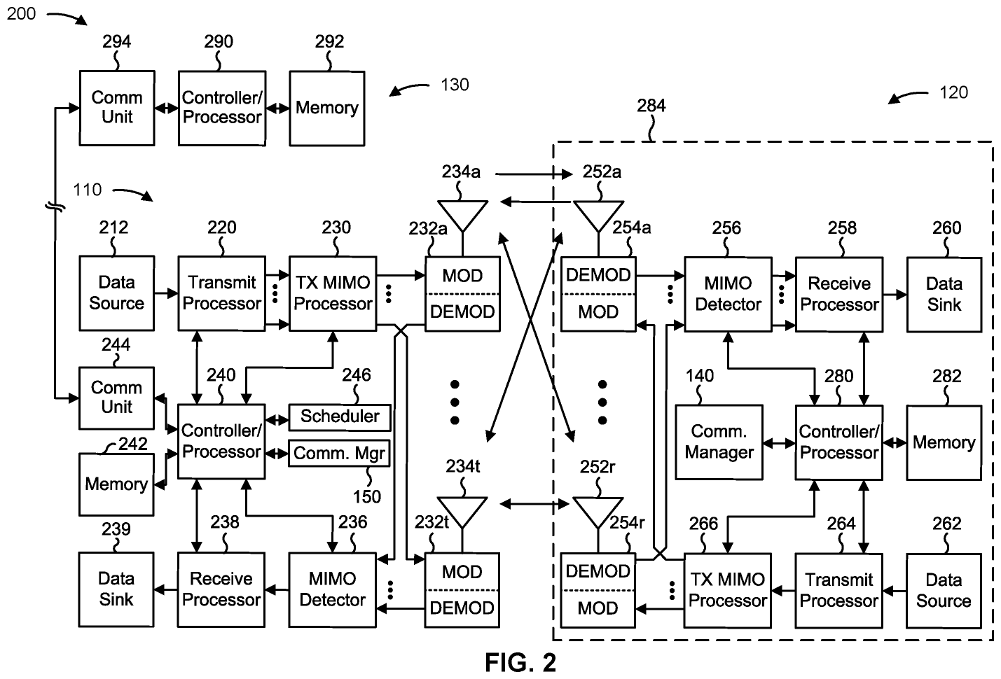

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

The controller/processor 240 of the base station 110, the controller/processor 280 of the UE 120, and/or any other component(s) of FIG. 2 may perform one or more techniques associated with configuring non-serving cell reference signal reporting, as described in more detail elsewhere herein. In some aspects, the network entity described herein is the base station 110, is included in the base station 110, or includes one or more components of the base station 110 shown in FIG. 2.

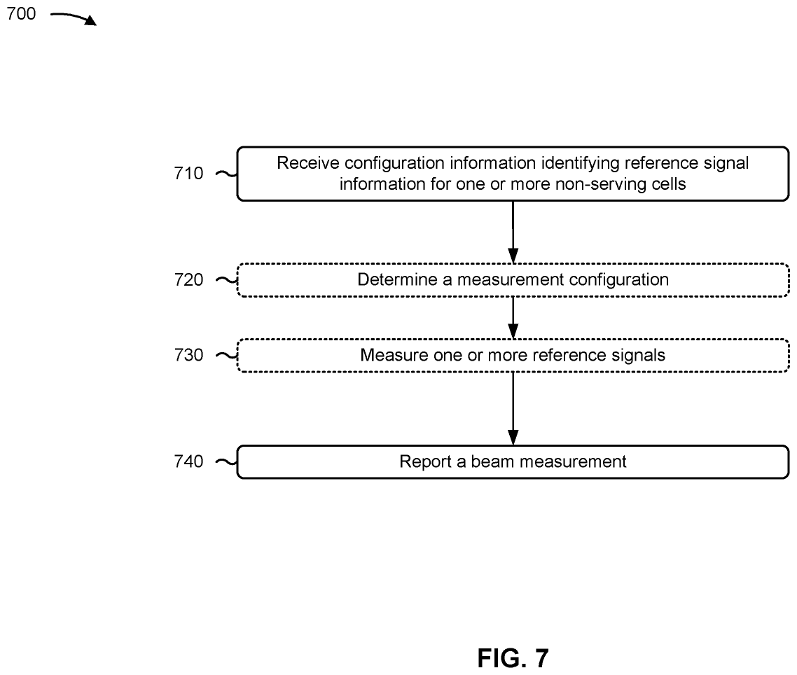

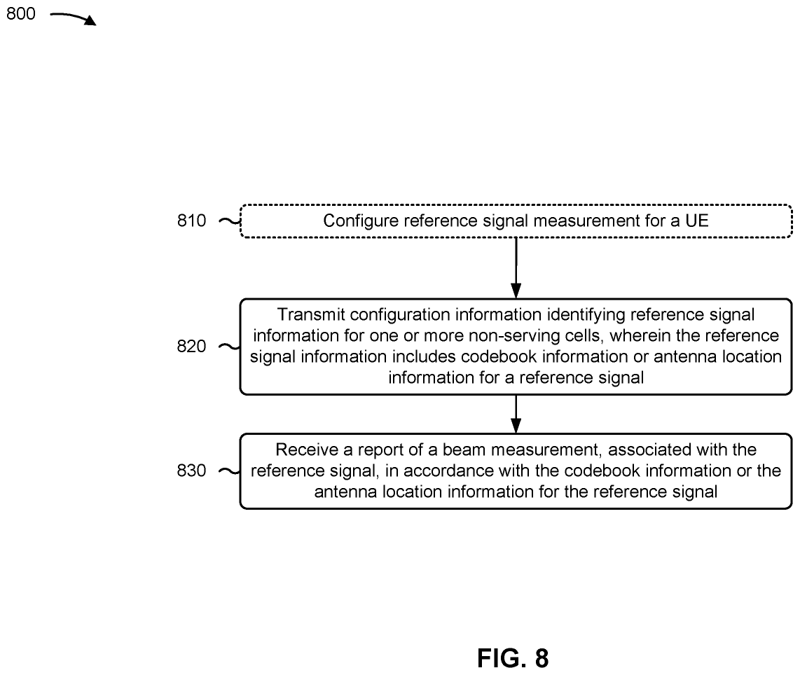

For example, the controller/processor 240 of the base station 110, the controller/processor 280 of the UE 120, and/or any other component(s) of FIG. 2 may perform or direct operations of, for example, method 700 of FIG. 7, method 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, method 700 of FIG. 7, method 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving configuration information identifying reference signal information for one or more non-serving cells, wherein the reference signal information includes codebook information or antenna location information for a reference signal; and/or means for reporting a beam measurement associated with the reference signal based at least in part on the codebook information or the antenna location information for the reference signal. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity, such as the base station 110, includes means for transmitting configuration information identifying reference signal information for one or more non-serving cells, wherein the reference signal information includes codebook information or antenna location information for a reference signal; and/or means for receiving a report of a beam measurement, associated with the reference signal, in accordance with the codebook information or the antenna location information for the reference signal. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

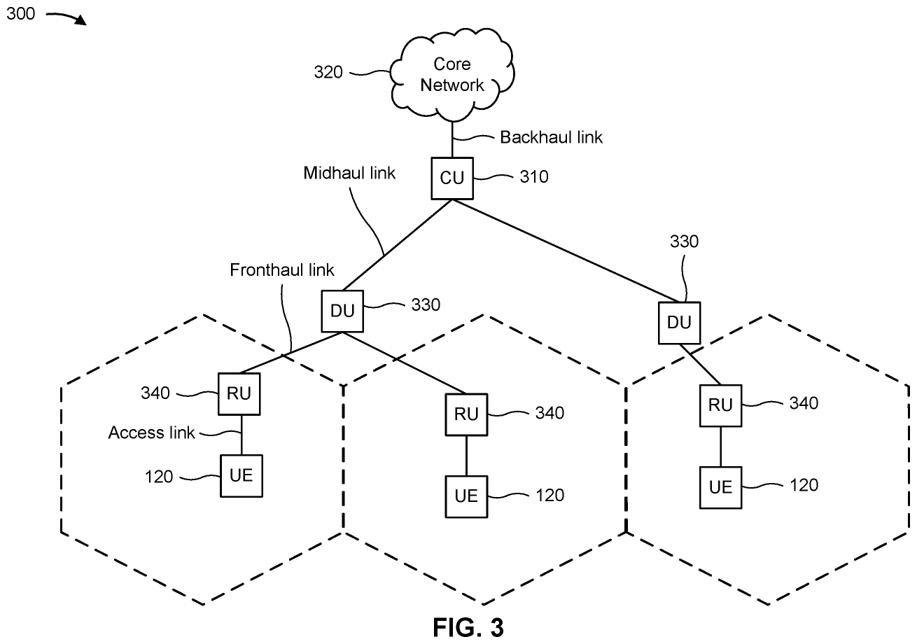

FIG. 3 is a diagram illustrating an example 300 of an O-RAN architecture, in accordance with the present disclosure. As shown in FIG. 3, the O-RAN architecture may include a control unit (CU) 310 that communicates with a core network 320 via a backhaul link. Furthermore, the CU 310 may communicate with one or more DUs 330 via respective midhaul links. The DUs 330 may each communicate with one or more RUs 340 via respective fronthaul links, and the RUs 340 may each communicate with respective UEs 120 via radio frequency (RF) access links. The DUs 330 and the RUs 340 may also be referred to as O-RAN DUS (O-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

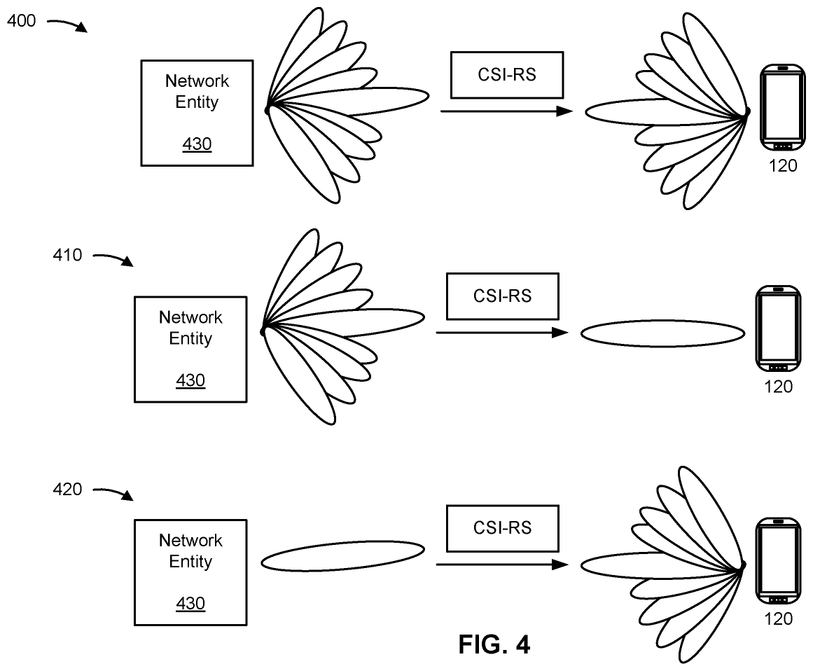

FIG. 4 is a diagram illustrating examples 400, 410, and 420 of channel state information (CSI) reference signal (RS) (CSI-RS) beam management procedures, in accordance with the present disclosure. As shown in FIG. 4, examples 400, 410, and 420 include a UE 120 in communication with a network entity 430 in a wireless network (e.g., wireless network 100). However, the devices shown in FIG. 4 are provided as examples, and the wireless network may support communication and beam management between other devices (e.g., between a UE 120 and a network entity 430 or TRP, between a mobile termination node and a control node, between an integrated access and backhaul (IAB) child node and an IAB parent node, and/or between a scheduled node and a scheduling node). The UE 120 and the network entity 430 may be in a connected state (e.g., a radio resource control (RRC) connected state).

As shown in FIG. 4, example 400 may include a network entity 430 and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network entity 430 to the UE 120. The CSI-RSs may be configured to be periodic CSI-RSs (P-CSI-RSs) (e.g., using RRC signaling), semi-persistent (SP) CSI-RSs (SP-CSI-RSs) (e.g., using media access control (MAC) control element (CE) (MAC-CE) signaling), and/or aperiodic (AP) CSI-RSs (AP-CSI-RSs) (e.g., using downlink control information (DCI)).

The first beam management procedure may include the network entity 430 performing beam sweeping over multiple transmit (Tx) beams. The network entity 430 may transmit a CSI-RS using each transmit beam for beam management. To enable the UE 120 to perform receive (Rx) beam sweeping, the network entity 430 may use a transmit beam to transmit (e.g., with repetitions) each CSI-RS at multiple times within the same RS resource set so that the UE 120 can sweep through receive beams in multiple transmission instances. For example, if the network entity 430 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network entity 430, the UE 120 may perform beam sweeping through the receive beams of the UE 120.

As a result, the first beam management procedure may enable the UE 120 to measure a CSI-RS on different transmit beams using different receive beams to support selection of network entity 430 transmit beam(s)/UE 120 receive beam(s) beam pair(s). The UE 120 may report the measurements to the network entity 430 to enable the network entity 430 to select one or more beam pair(s) for communication between the network entity 430 and the UE 120. While example 400 has been described in connection with CSI-RSs, the first beam management process may also use synchronization signal blocks (SSBs) for beam management in a similar manner as described above. For example, UE 120 and network entity 430 may perform SSB beam sweeping (e.g., during initial access along with SSB and random access channel (RACH) association) to select a beam pair with a course granularity (e.g., by using wider, layer 1 (L1) beams) before performing CSI-RS beam sweeping (e.g., in a connected mode) to select a beam pair with a finer granularity (e.g., using hierarchical beam refinement, as described herein).

As shown in FIG. 4, example 410 may include a network entity 430 and a UE 120 communicating to perform beam management using CSI-RSs. Example 410 depicts a second beam management procedure (e.g., P2 CSI-RS beam management). The second beam management procedure may be referred to as a beam refinement procedure, a hierarchical beam refinement procedure (e.g., a P1, P2, or P3 procedure, as described herein), a base station beam refinement procedure, a TRP beam refinement procedure, and/or a transmit beam refinement procedure. As shown in FIG. 4 and example 410, CSI-RSs may be configured to be transmitted from the network entity 430 to the UE 120. The CSI-RSs may be configured to be aperiodic (e.g., using DCI). The second beam management procedure may include the network entity 430 performing beam sweeping over one or more transmit beams. The one or more transmit beams may be a subset of all transmit beams associated with the network entity 430 (e.g., determined based at least in part on measurements reported by the UE 120 in connection with the first beam management procedure). The network entity 430 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network entity 430 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network entity 430 to the UE 120. The CSI-RSs may be configured to be aperiodic (e.g., using DCI). The third beam management process may include the network entity 430 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network entity 430 and/or the UE 120 to select a best receive beam based at least in part on reported measurements received from the UE 120 (e.g., of the CSI-RS of the transmit beam using the one or more receive beams). In some cases, beam failure recovery procedures may be used to recover a beam after a detected beam failure or radio link failure procedures may be used to identify a new beam after a detected beam or radio link failure.

In some cases, UE 120 and network entity 430 may use beam prediction to reduce a quantity of beam measurements associated with selecting a beam (e.g., in one or more of the aforementioned beam management procedures). For example, when beam prediction is not used, UE 120 and network entity 430 may communicate (e.g., by transmitting a CSI-RS and performing measurements and by reporting the measurements) on each beam across a beam sweep. However, when, for example, network entity 430 performs a beam prediction procedure, network entity 430 and UE 120 may forgo transmission or measurement of one or more beams of the beam sweep. For example, for a set of consecutive beams (e.g., consecutive with regard to beam angle) that are configured for network entity 430, network entity 430 may forgo transmission of one or more beams within the set of consecutive beams. In this case, network entity 430 may completely forgo one or more beam transmissions or may selectively transmit one or more beams (e.g., sometimes forgo one or more beam transmissions) based at least in part on whether UE 120 is performing initial access or not, based at least in part on how recently the one or more beams were transmitted, or based at least in part on a configured periodicity, among other examples. Additionally, or alternatively, network entity 430 may transmit all of the beams in the set of consecutive beams, but UE 120 may forgo measurement and/or reporting of one or more beams within the set of consecutive beams. In these cases, network entity 430 and/or UE 120 may interpolate (e.g., using artificial intelligence or another prediction technique) from measured beams to predict beam measurements (e.g., an RSRP) for one or more beams that have not been transmitted and/or measured. For example, UE 120 may predict a beam measurement of a beam, which UE 120 has selected to forgo measuring, based at least in part on one or more other beam measurements and may report the predicted beam measurement to network entity 430. Additionally, or alternatively, UE 120 may forgo reporting a beam measurement for the beam, which UE 120 has selected to forgo measuring, and network entity 430 may predict a beam measurement for the beam. In this case, network entity 430 may use the predicted beam measurement with actual beam measurements to configure communications, as described herein.

Similarly, network entity 430 and/or UE 120 may forgo transmission and measurement of beams with a higher granularity. For example, rather than a first beam management procedure using wide beams and a second beam management procedure using narrow beams, network entity 430 may forgo transmission and/or UE 120 may forgo measurement of the narrow beams. In this case, network entity 430 and/or UE 120 may predict beam measurements for the narrow beams (e.g., that have not been transmitted and/or measured) based at least in part on beam measurements of the wide beams (e.g., that have been transmitted and measured) and/or based at least in part on past beam predictions or measurements. In these ways, network entity 430 and/or UE 120 reduce a quantity of UE-side beam measurements and/or a UE-specific communication overhead, thereby improving UE performance and/or network performance.

As indicated above, FIG. 4 is provided as an example of beam management procedures. Other examples of beam management procedures may differ from what is described with respect to FIG. 4. For example, the UE 120 and the network entity 430 may perform the third beam management procedure before performing the second beam management procedure, and/or the UE 120 and the network entity 430 may perform a similar beam management procedure to select a UE transmit beam.

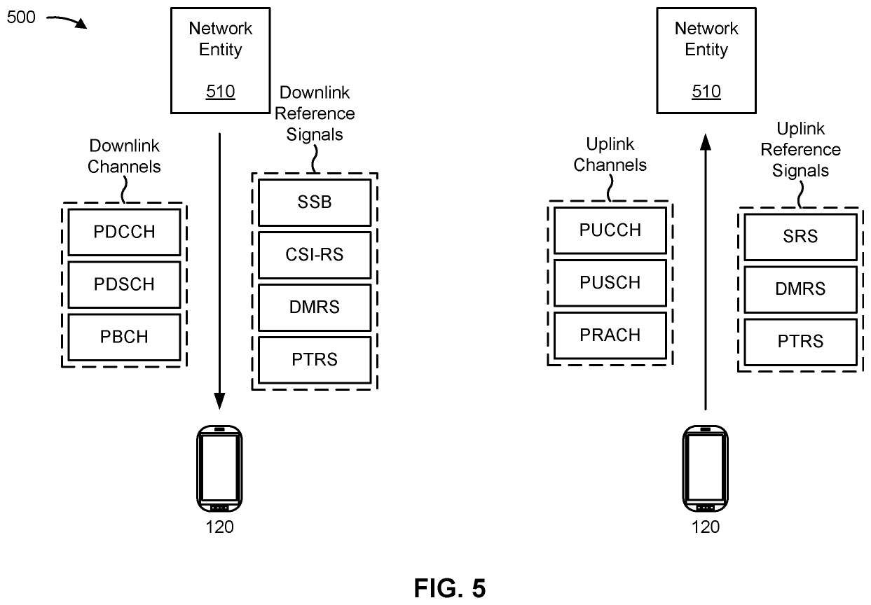

FIG. 5 is a diagram illustrating an example 500 of physical channels and reference signals in a wireless network, in accordance with the present disclosure. As shown in FIG. 5, downlink channels and downlink reference signals may carry information from a network entity 510 to a UE 120, and uplink channels and uplink reference signals may carry information from a UE 120 to a network entity 510.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. The UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. The network entity 510 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network entity 510 may configure a set of CSI-RSs for the UE 120, and the UE 120 may measure the configured set of CSI-RSs. Based at least in part on the measurements, the UE 120 may perform channel estimation and may report channel estimation parameters to the network entity 510 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network entity 510 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network entity 510 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. The network entity 510 may then calculate a position of the UE 120 based on the RSTD measurements reported by the UE 120.

An SRS may carry information used for uplink channel estimation, which may be used for scheduling, link adaptation, precoder selection, or beam management, among other examples. The network entity 510 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network entity 510 may measure the SRSs, may perform channel estimation based at least in part on the measurements, and may use the SRS measurements to configure communications with the UE 120.

As indicated above, FIG. 5 is provided as an example. Other examples may differ from what is described with regard to FIG. 5.

A UE and a network entity may communicate to identify characteristics of a network and/or link that the UE and the network entity can use for communication. For example, a UE may perform a measurement of a reference signal, such as a CSI-RS or an SSB, and may report the measurement to the network entity. The report may include information identifying a layer 1 (L1) reference signal received power (RSRP) value or a signal-to-interference-plus-noise ratio (SINR) value for the reference signal.

The network entity may use the report of the measurement of the reference signal to select a beam for use in communication with the UE. Additionally, or alternatively, the network entity may use the report for configuring cells, activating cells, deactivating cells, configuring other network entities, triggering handovers or radio link failures (RLFs), or enabling recoveries from RLFs, among other examples. Event-driven reporting is an enhancement to network and/or link measurement procedures that may enable a reduction in a quantity of beam measurements and/or reports of beam measurements, which may reduce network congestion or message overhead, among other examples. One example of an event is that the UE may use a serving cell reference signal received power (RSRP) threshold to trigger one or more measurements and reporting of the one or more measurements. This may reduce a frequency with which the UE performs some measurements by allowing the UE to forgo performing some measurements when an event, such as satisfaction of a threshold, has not or is not occurring.

However, the UE may lack information indicating which reference signals the UE is to measure and which reference signals the UE can forgo measuring without causing a negative impact to an ability of a network entity to configure communications within a network. Using a single serving cell RSRP threshold (e.g., a pre-configured or pre-defined threshold) does not obviate a need for the UE to determine which reference signals should be monitored and which reference signals can be skipped (e.g., not monitored or not reported). Accordingly, the UE may monitor, measure, and report more reference signals than the network entity is to use, which results in an excessive utilization of network resources, or fewer reference signals than the network entity is to use, which results in inefficient or ineffective control and configuration of the network.

Some aspects described herein enable a network entity to provide a UE with configuration information to enable the UE to perform event-driven reporting. For example, a network entity may provide a UE with codebook information or location information with which the UE can identify which non-serving cells, of a plurality of available non-serving cells, the UE is to measure and report on. The UE may use the configuration information to identify resources for measuring non-serving cell reference signals, measure the non-serving cell reference signals, and transmit reports regarding the non-serving cell reference signals. In this way, the network entity and the UE enable reduced power consumption, network traffic, or message overhead relative to attempting to perform event-driven reporting without the aforementioned configuration information.

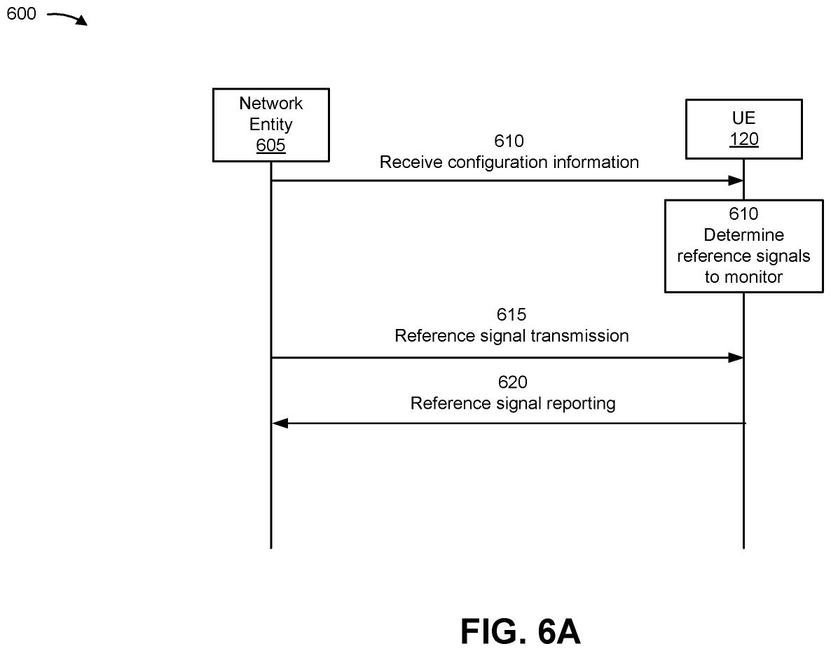

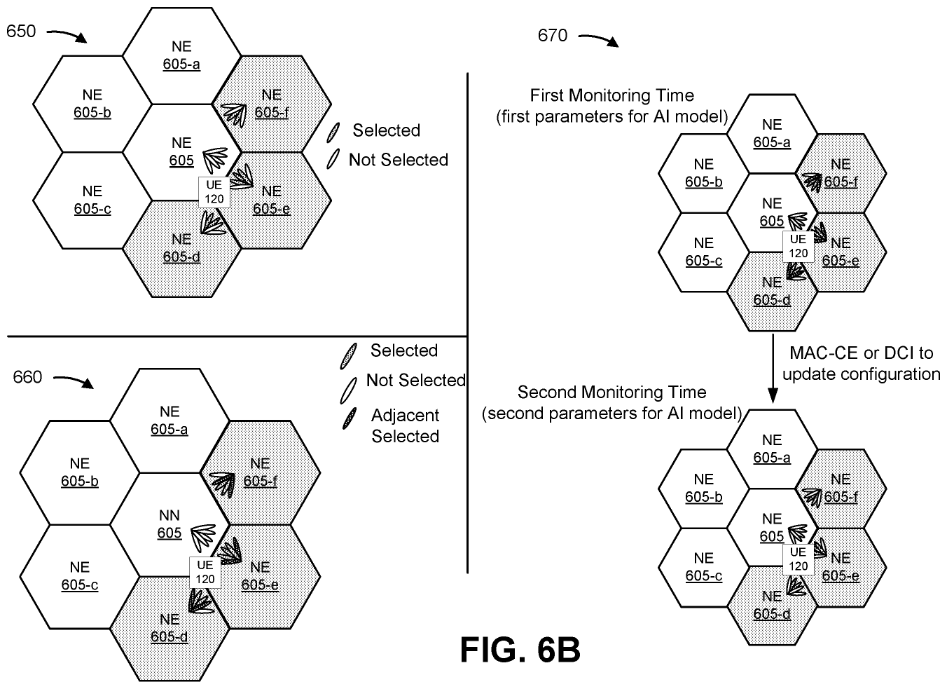

FIGS. 6A and 6B are diagrams of an example 600 associated with configuring non-serving cell reference signal reporting, in accordance with the present disclosure. As shown in FIGS. 6A and 6B, a network entity 605 (e.g., base station 110, a CU, a DU, and/or an RU) may communicate with a UE 120. In some aspects, the network entity 605 and the UE 120 may be part of a wireless network (e.g., wireless network 100). The UE 120 and the network entity 605 may have established a wireless connection prior to operations shown in FIGS. 6A and 6B.

At 610, the network entity 605 may transmit, and the UE 120 may receive, configuration information. For example, UE 120 may receive radio resource control (RRC), medium access control (MAC) control element (CE) (MAC-CE), or downlink control information (DCI) signaling identifying one or more codebooks or antenna locations for one or more reference signals. The one or more reference signals may include one or more SSBs or one or more CSI-RSs associated with one or more non-serving cells. The one or more non-serving cells may include (inactive) serving cells with physical cell identifiers (PCIs) that are different from a PCI of an activated serving cell. In other words, a non-serving cell may include a cell, which has been specified as a serving cell among multiple cells specified as serving cells, but which is not active as the serving cell for a particular UE 120. In this case, a non-serving cell may include, for example, any cell which is not an active (or activated) serving cell. In some aspects, the one or more non-serving cells may include one or more serving cells with PCIs that are different from a PCI of a serving cell that the UE 120 is configured to use for reporting of measurement results. In other words, when a first serving cell is configured for use in reporting measurement results (by a particular UE 120) and a second serving cell is not configured for use in reporting measurement results (by the particular UE 120), the second serving cell may be classified as a non-serving cell with respect to the particular UE 120. In this case, a non-serving cell may include, for example, any cell which is not configured for reporting of measurement results.

In one example, the UE 120 receives RRC configuration information. In such an example, in some aspects, the RRC configuration information may include one or more information elements (IEs) associated with or within a CSI report setting (CSI-ReportConfig) associated with an SSB resource set (CSI-SSB-ResourceSet) for layer 1 (L1) RSRP (L1-RSRP) or SINR reporting with non-serving cells. For example, the network entity 605 may include an IE within an RRC configuration of a CSI-SSB-ResourceSet or within an RRC configuration of a CSI-RS or SSB resource associated with a non-serving cell. Additionally, or alternatively, the UE 120 may receive RRC configuration information configuring an analytical model, as described in more detail below.

In another example, the UE 120 receives MAC-CE or DCI configuration information. For example, the network entity 605 may transmit MAC-CE or DCI signaling to overwrite a codebook configured using RRC signaling with a codebook for determining whether to measure and report on one or more reference signals of one or more non-serving cells. In this way, the network entity 605 may dynamically provide codebook information or location information regarding one or more additional reference signals (e.g., not configured using RRC signaling). Additionally, or alternatively, the network entity 605 may dynamically update parameters of an analytical model or artificial intelligence (AI) model (e.g., that was initially configured using RRC signaling), as described in more detail herein.

In some aspects, the configuration information may include codebook configuration information. For example, the UE 120 may receive information identifying an azimuth angle or spread, or an elevation or spread, among other examples, for one or more antennas associated with one or more non-serving cells.

In some aspects, the configuration information may include location information. For example, the UE 120 may receive information identifying a location of an antenna associated with providing communications for one or more non-serving cells. In this case, the location information may identify the location by providing a value in a local coordinate system (LCS) or a global coordinate system (GCS) from which the UE 120 may identify the location.

In some aspects, the UE 120 may receive configuration information identifying one or more parameters for determining a configuration for measuring or reporting information associated with one or more reference signals. For example, the UE 120 may receive configuration information identifying one or more serving cell PCIs, one or more non-serving cell PCIs, or one or more non-serving cell PCI groups, among other examples, from which the UE 120 can determine which non-serving cells to monitor for reference signals.

At 610, 615, and 620, the UE 120 may determine one or more reference signals to monitor, monitor for the one or more reference signals, and transmit reporting regarding the one or more reference signals. For example, the UE 120 may use the configuration information, such as the codebook information or the location information, to determine when and how to measure and/or report one or more L1-RSRP values or SINR values associated with one or more reference signals received from one or more non-serving cells. In this case, the UE 120 may monitor and measure one or more selected reference signals from non-serving cells and may report the measurements of the one or more selected reference signals (e.g., using reference signal reporting resources on the uplink).

In some aspects, the UE 120 may use an analytical model to determine which reference signals to measure and report to the network entity 605. The analytical model may be a statistical model representing including one or more thresholds or criteria based at least in part on which the UE 120 may select a non-serving cell, beam, or reference signal to monitor, measure, and/or report. For example, the UE 120 may use the analytical model to analyze information regarding a location of the UE 120 and location information, from the configuration information, regarding a location of an antenna of a non-serving cell.

In such examples, the UE 120 may determine to measure a non-serving cell SSB or CSI-RS with a field of view (FoV) (e.g., which may correspond to an angular spread of one or more beams thereof) that covers the UE 120 and is within a threshold proximity of the UE 120 (e.g., within 200 meters (m)). For example, in FIG. 6B and at 650, the UE 120 may identify a first set of beams a, b, c, d, e, and f that have an FoV that includes the UE 120 and are from an antenna (of network entities (shown as “NE”) 605-d, 605-e, and 605-f) within a threshold proximity of the UE 120. In this case, the UE 120 may select the first set of beams to monitor and report reference signals associated with the first set of beams in accordance with the analytical model and the configuration information. Additionally, or alternatively, the UE 120 may determine to measure one or more reference signals with FoVs that are adjacent to a reference signal with an FoV that covers the UE 120 and is within a threshold proximity of the UE 120. For example, in FIG. 6B and at 660, the UE 120 may identify a second set of beams that are adjacent to the selected first set of beams. In this case, the UE 120 may monitor the adjacent, selected, second set of beams and report reference signals associated with the second set of beams in accordance with the analytical model and the configuration information.

In some aspects, the UE 120 may use an AI model to determine which reference signals to measure and report to the network entity 605. For example, the UE 120 may use the configuration information (e.g., codebook information or location information) as inputs to an AI model and receive an indication of one or more reference signals to measure to enable the network entity 605 to control and/or configure a network. In this case, the AI model may be a neural network model or a deep learning model trained to determine effects of different measurements of reference signals under different conditions on a control or configuration of a network (e.g., a throughput, a quantity of handovers, a likelihood of RLF), among other examples. For example, in FIG. 6B and at 670, the UE 120 may use a first AI model (e.g., that is RRC configured) to determine which reference signals to measure and report at a first time and may, after receiving MAC-CE or DCI signaling, use a second AI model to determine which reference signals to measure and report at a second time. In this case, the first AI model and the second AI model may be the same AI model, but with different parameters (e.g., the UE 120 may receive first parameters via the RRC signaling indicating that the UE 120 is to monitor 2 angularly adjacent beams with respect to in-coverage beams and second parameters via the MAC-CE or DCI signaling indicating that the UE 120 is to monitor 0 or 4 angularly adjacent beams with respect to the in-coverage beams, as shown).

As indicated above, FIGS. 6A and 6B are provided as an example. Other examples may differ from what is described with regard to FIGS. 6A and 6B.

FIG. 7 is a flowchart of an example method 700 of wireless communication. The method 700 may be performed by, for example, a UE (e.g., UE 120).

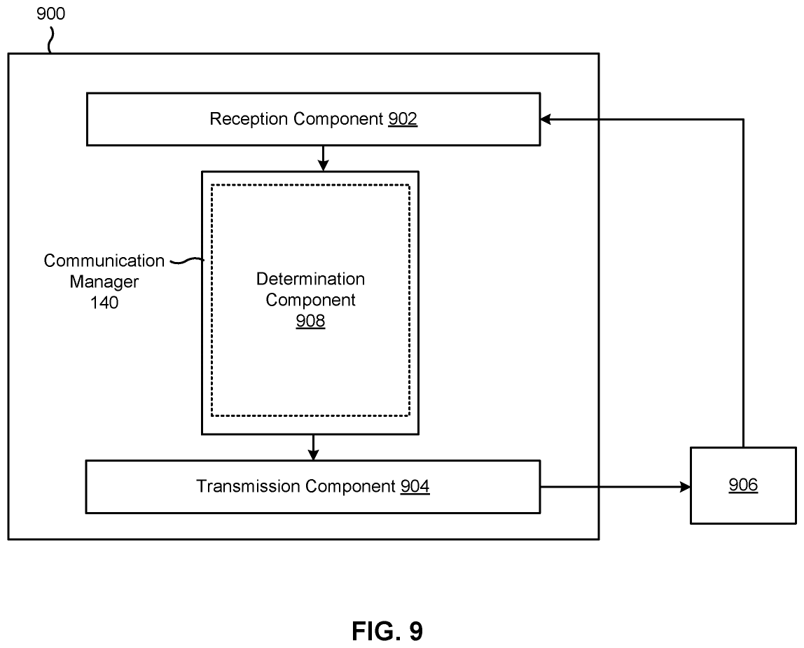

At 710, the UE may receive configuration information identifying reference signal information for one or more non-serving cells. For example, the UE (e.g., using communication manager 140 and/or reception component 902, depicted in FIG. 9) may receive configuration information identifying reference signal information for one or more non-serving cells, wherein the reference signal information includes codebook information or antenna location information for a reference signal, as described above in connection with, for example, FIG. 6A and at 610.

In some aspects, receiving the configuration information comprises receiving the configuration information via at least one of an RRC message, a MAC-CE, or DCI. In some aspects, the codebook information includes at least one of a beam azimuth angle or spread, a beam elevation angle or spread, a serving cell physical cell identifier, or a non-serving cell physical cell identifier or physical cell identifier group. In some aspects, the antenna location information includes a location configuration for an antenna associated with transmitting the reference signal, wherein the location configuration includes at least one of a local coordinate system value, or a global coordinate system value.

At 720, in some aspects, the UE may determine a measurement configuration. For example, the UE (e.g., using communication manager 140 and/or determination component 908, depicted in FIG. 9) may determine one or more reference signals that the UE is to monitor and measure on one or more non-serving cells. In some aspects, method 700 includes determining, based at least in part on the configuration information, a measurement configuration for the beam measurement or a reporting configuration for the beam measurement. In some aspects, method 700 includes determining the measurement configuration or the reporting configuration based at least in part on at least one of a serving cell physical cell identifier, a target non-serving cell physical cell identifier or physical cell identifier group, a layer-1 reference signal received power or a signal-to-interference-and-noise-ratio of the reference signal, an output of a statistical analysis, or an output of an artificial intelligence analysis. In some aspects, the output of the statistical analysis is based at least in part on a set of analytical inputs including a UE location or the configuration information.

In some aspects, the output of the artificial intelligence analysis is based at least in part on a set of model inputs or a set of model parameters including a UE location or the configuration information. In some aspects, the artificial intelligence analysis or the statistical analysis is configured based at least in part on RRC signaling or is updated based at least in part on MAC-CE, or DCI, signaling. In some aspects, an RRC message includes an information element conveying the configuration information, and the information element is included in at least one of a channel state information report setting associated with a synchronization signal block resource set for the reference signal for the one or more non-serving cells, an RRC configuration for the synchronization signal block resource set, or an RRC configuration for a reference signal resource associated with the one or more non-serving cells. In some aspects, a MAC-CE or DCI includes a field conveying the configuration information, wherein the field is associated with at least one of overwriting the codebook information, indicating additional codebook information for one or more reference signals, or indicating additional location information for the one or more reference signals.

At 730, in some aspects, the UE may measure one or more reference signals. For example, the UE (e.g., using communication manager 140 and/or reception component 902, depicted in FIG. 9) may measure one or more reference signals of one or more non-serving cells. In some aspects, the UE may measure one or more reference signals selected based at least in part on an output of an analytical model or an AI model.

At 740, the UE may report a beam measurement. For example, the UE (e.g., using communication manager 140 and/or transmission component 904, depicted in FIG. 9) may report a beam measurement associated with the reference signal based at least in part on the codebook information or the antenna location information for the reference signal, as described above in connection with, for example, FIG. 6A and at 620.

In some aspects, the reference signal includes a synchronization signal block or a channel state information reference signal. In some aspects, the one or more non-serving cells are associated with a first one or more corresponding physical cell identifiers that differ from a second physical cell identifier of a serving cell of the UE. In some aspects, the serving cell is an activated serving cell or a serving cell for reporting the beam measurement. In some aspects, the beam measurement includes a layer-1 reference signal received power or a signal-to-interference-and-noise-ratio.

Although FIG. 7 shows example blocks of method 700, in some aspects, method 700 may include additional blocks, fewer blocks, different blocks, or differently arranged blocks than those depicted in FIG. 7. Additionally, or alternatively, two or more of the blocks of method 700 may be performed in parallel.

FIG. 8 is a flowchart of an example method 800 of wireless communication. The method 800 may be performed by, for example, a network entity (e.g., network entity 605).

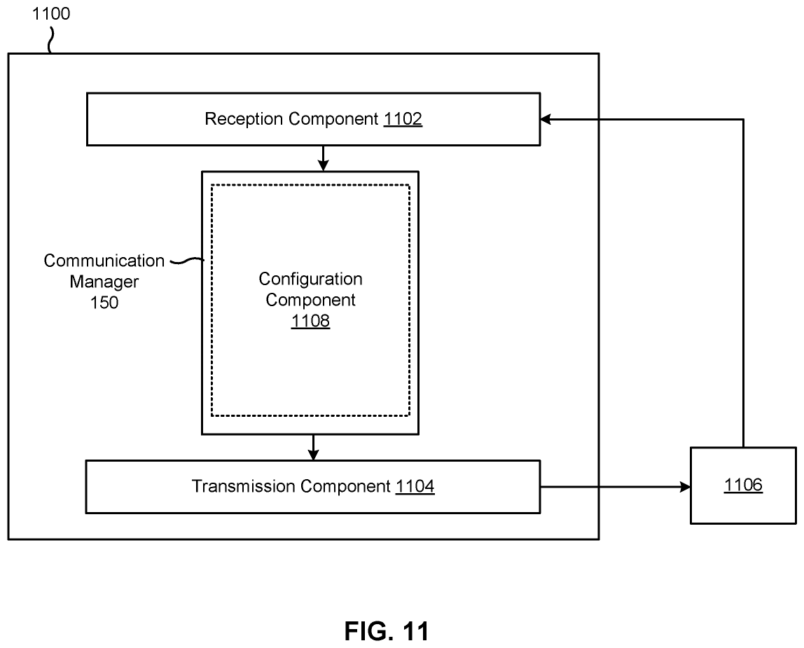

At 810, in some aspects, the network entity may configure reference signal measurement for a UE. For example, the network entity (e.g., using communication manager 150 and/or configuration component 1108, depicted in FIG. 11) may configure one or more parameters that are to be included in configuration information transmitted to the UE. In some aspects, the one or more parameters include one or more parameters for an analytical model or an AI model.

At 820, the network entity may transmit configuration information identifying reference signal information for one or more non-serving cells, wherein the reference signal information includes codebook information or antenna location information for a reference signal. For example, the network entity (e.g., using communication manager 150 and/or transmission component 1104, depicted in FIG. 11) may transmit configuration information identifying reference signal information for one or more non-serving cells, wherein the reference signal information includes codebook information or antenna location information for a reference signal, as described above in connection with, for example, FIG. 6A and at 610.

In some aspects, transmitting the configuration information comprises transmitting the configuration information via at least one of a radio resource control message, a MAC-CE, or downlink control information. In some aspects, the one or more non-serving cells are associated with a first one or more corresponding physical cell identifiers that differ from a second physical cell identifier of a serving cell of the UE. In some aspects, the serving cell is an activated serving cell or a serving cell for reporting the beam measurement.

In some aspects, the codebook information includes at least one of a beam azimuth angle or spread, a beam elevation angle or spread, a serving cell physical cell identifier, or a non-serving cell physical cell identifier or physical cell identifier group. In some aspects, the antenna location information includes a location configuration for an antenna associated with transmitting the reference signal, wherein the location configuration includes at least one of a local coordinate system value, or a global coordinate system value. In some aspects, a measurement configuration for the beam measurement or a reporting configuration for the beam measurement is based at least in part on the configuration information.

In some aspects, the measurement configuration or the reporting configuration is based at least in part on at least one of a serving cell physical cell identifier, a target non-serving cell physical cell identifier or physical cell identifier group, a layer-1 reference signal received power or a signal-to-interference-and-noise-ratio of the reference signal, an output of a statistical analysis, or an output of an artificial intelligence analysis. In some aspects, the output of the statistical analysis is based at least in part on a set of analytical inputs including a UE location or the configuration information. In some aspects, the output of the artificial intelligence analysis is based at least in part on a set of model inputs or a set of model parameters including a user equipment location or the configuration information.

In some aspects, the artificial intelligence analysis or the statistical analysis is configured based at least in part on radio resource control signaling or is updated based at least in part on MAC-CE, or downlink control information, signaling. In some aspects, a radio resource control message includes an information element conveying the configuration information, and the information element is included in at least one of a channel state information report setting associated with a synchronization signal block resource set for the reference signal for the one or more non-serving cells, a radio resource control configuration for the synchronization signal block resource set, or a radio resource control configuration for a reference signal resource associated with the one or more non-serving cells. In some aspects, a MAC-CE or DCI includes a field conveying the configuration information, wherein the field is associated with at least one of overwriting the codebook information, indicating additional codebook information for one or more reference signals, or indicating additional location information for the one or more reference signals.

At 830, the network entity may receive a report of a beam measurement, associated with the reference signal, in accordance with the codebook information or the antenna location information for the reference signal. For example, the network entity (e.g., using communication manager 150 and/or reception component 1102, depicted in FIG. 11) may receive a report of a beam measurement, associated with the reference signal, in accordance with the codebook information or the antenna location information for the reference signal, as described above in connection with, for example, FIG. 6A and at 620. In some aspects, the reference signal includes a synchronization signal block or a channel state information reference signal. In some aspects, the beam measurement includes a layer-1 reference signal received power or a signal-to-interference-and-noise-ratio.

Although FIG. 8 shows example blocks of method 800, in some aspects, method 800 may include additional blocks, fewer blocks, different blocks, or differently arranged blocks than those depicted in FIG. 8. Additionally, or alternatively, two or more of the blocks of method 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include a determination component 908, among other examples.

In some aspects, the apparatus 900 may be configured to perform one or more operations described herein in connection with FIGS. 6A-6B. Additionally, or alternatively, the apparatus 900 may be configured to perform one or more processes described herein, such as method 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive configuration information identifying reference signal information for one or more non-serving cells, wherein the reference signal information includes codebook information or antenna location information for a reference signal. The transmission component 904 may report a beam measurement associated with the reference signal based at least in part on the codebook information or the antenna location information for the reference signal.

The determination component 908 may determine, based at least in part on the configuration information, a measurement configuration for the beam measurement or a reporting configuration for the beam measurement. The determination component 908 may determine the measurement configuration or the reporting configuration based at least in part on at least one of a serving cell physical cell identifier, a target non-serving cell physical cell identifier or physical cell identifier group, a layer-1 reference signal received power or a signal-to-interference-and-noise-ratio of the reference signal, an output of a statistical analysis, or an output of an artificial intelligence analysis.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

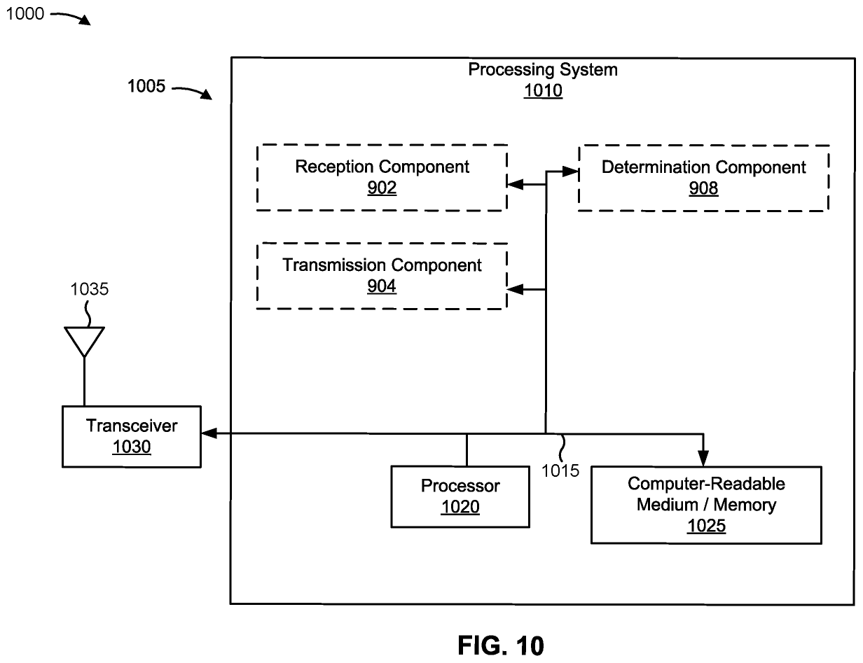

FIG. 10 is a diagram illustrating an example 1000 of a hardware implementation for an apparatus 1005 employing a processing system 1010. The apparatus 1005 may be a UE.

The processing system 1010 may be implemented with a bus architecture, represented generally by the bus 1015. The bus 1015 may include any number of interconnecting buses and bridges depending on the specific application of the processing system 1010 and the overall design constraints. The bus 1015 links together various circuits including one or more processors and/or hardware components, represented by the processor 1020, the illustrated components, and the computer-readable medium/memory 1025. The bus 1015 may also link various other circuits, such as timing sources, peripherals, voltage regulators, and/or power management circuits.

The processing system 1010 may be coupled to a transceiver 1030. The transceiver 1030 is coupled to one or more antennas 1035. The transceiver 1030 provides a means for communicating with various other apparatuses over a transmission medium. The transceiver 1030 receives a signal from the one or more antennas 1035, extracts information from the received signal, and provides the extracted information to the processing system 1010, specifically the reception component 902. In addition, the transceiver 1030 receives information from the processing system 1010, specifically the transmission component 904, and generates a signal to be applied to the one or more antennas 1035 based at least in part on the received information.

The processing system 1010 includes a processor 1020 coupled to a computer-readable medium/memory 1025. The processor 1020 is responsible for general processing, including the execution of software stored on the computer-readable medium/memory 1025. The software, when executed by the processor 1020, causes the processing system 1010 to perform the various functions described herein for any particular apparatus. The computer-readable medium/memory 1025 may also be used for storing data that is manipulated by the processor 1020 when executing software. The processing system further includes at least one of the illustrated components. The components may be software modules running in the processor 1020, resident/stored in the computer readable medium/memory 1025, one or more hardware modules coupled to the processor 1020, or some combination thereof.

In some aspects, the processing system 1010 may be a component of the UE 120 and may include the memory 282 and/or at least one of the TX MIMO processor 266, the RX processor 258, and/or the controller/processor 280. In some aspects, the apparatus 1005 for wireless communication includes means for receiving configuration information identifying reference signal information for one or more non-serving cells, wherein the reference signal information includes codebook information or antenna location information for a reference signal; and means for reporting a beam measurement associated with the reference signal based at least in part on the codebook information or the antenna location information for the reference signal. The aforementioned means may be one or more of the aforementioned components of the apparatus 900 and/or the processing system 1010 of the apparatus 1005 configured to perform the functions recited by the aforementioned means. As described elsewhere herein, the processing system 1010 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 10 is provided as an example. Other examples may differ from what is described in connection with FIG. 10.

FIG. 11 is a diagram of an example apparatus 1100 for wireless communication. The apparatus 1100 may be a network entity, or a network entity may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a configuration component 1108, among other examples.

In some aspects, the apparatus 1100 may be configured to perform one or more operations described herein in connection with FIGS. 6A-6B. Additionally, or alternatively, the apparatus 1100 may be configured to perform one or more processes described herein, such as method 800 of FIG. 8. In some aspects, the apparatus 1100 and/or one or more components shown in FIG. 11 may include one or more components of the network entity described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network entity described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network entity described in connection with FIG. 2. In some aspects, the transmission component 1104 may be co-located with the reception component 1102 in a transceiver.

The transmission component 1104 may transmit configuration information identifying reference signal information for one or more non-serving cells, wherein the reference signal information includes codebook information or antenna location information for a reference signal. The reception component 1102 may receive a report of a beam measurement, associated with the reference signal, in accordance with the codebook information or the antenna location information for the reference signal. The configuration component 1108 may generate or obtain the configuration information, such as the codebook information or the antenna location information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

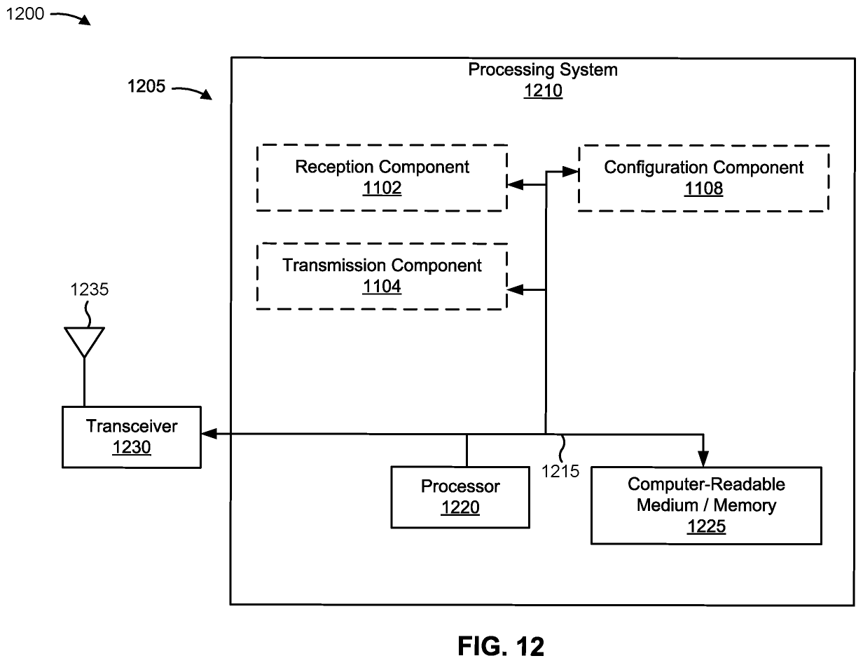

FIG. 12 is a diagram illustrating an example 1200 of a hardware implementation for an apparatus 1205 employing a processing system 1210. The apparatus 1205 may be a network entity.

The processing system 1210 may be implemented with a bus architecture, represented generally by the bus 1215. The bus 1215 may include any number of interconnecting buses and bridges depending on the specific application of the processing system 1210 and the overall design constraints. The bus 1215 links together various circuits including one or more processors and/or hardware components, represented by the processor 1220, the illustrated components, and the computer-readable medium/memory 1225. The bus 1215 may also link various other circuits, such as timing sources, peripherals, voltage regulators, and/or power management circuits.

The processing system 1210 may be coupled to a transceiver 1230. The transceiver 1230 is coupled to one or more antennas 1235. The transceiver 1230 provides a means for communicating with various other apparatuses over a transmission medium. The transceiver 1230 receives a signal from the one or more antennas 1235, extracts information from the received signal, and provides the extracted information to the processing system 1210, specifically the reception component 1102. In addition, the transceiver 1230 receives information from the processing system 1210, specifically the transmission component 1104, and generates a signal to be applied to the one or more antennas 1235 based at least in part on the received information.

The processing system 1210 includes a processor 1220 coupled to a computer-readable medium/memory 1225. The processor 1220 is responsible for general processing, including the execution of software stored on the computer-readable medium/memory 1225. The software, when executed by the processor 1220, causes the processing system 1210 to perform the various functions described herein for any particular apparatus. The computer-readable medium/memory 1225 may also be used for storing data that is manipulated by the processor 1220 when executing software. The processing system further includes at least one of the illustrated components. The components may be software modules running in the processor 1220, resident/stored in the computer readable medium/memory 1225, one or more hardware modules coupled to the processor 1220, or some combination thereof.

In some aspects, the processing system 1210 may be a component of the base station 110 or a sub-component of a component of a disaggregated base station, described herein with regard to FIG. 3, and may include the memory 242 and/or at least one of the TX MIMO processor 230, the RX processor 238, and/or the controller/processor 240. In some aspects, the apparatus 1205 for wireless communication includes means for transmitting configuration information identifying reference signal information for one or more non-serving cells, wherein the reference signal information includes codebook information or antenna location information for a reference signal; and/or means for receiving a report of a beam measurement, associated with the reference signal, in accordance with the codebook information or the antenna location information for the reference signal. The aforementioned means may be one or more of the aforementioned components of the apparatus 1100 and/or the processing system 1210 of the apparatus 1205 configured to perform the functions recited by the aforementioned means. As described elsewhere herein, the processing system 1210 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 12 is provided as an example. Other examples may differ from what is described in connection with FIG. 12.

The following provides an overview of some Aspects of the present disclosure:

Aspect 1: A method of wireless communication performed by a user equipment (UE), comprising: receiving configuration information identifying reference signal information for one or more non-serving cells, wherein the reference signal information includes codebook information or antenna location information for a reference signal; and reporting a beam measurement associated with the reference signal based at least in part on the codebook information or the antenna location information for the reference signal.

Aspect 2: The method of Aspect 1, wherein receiving the configuration information comprises: receiving the configuration information via at least one of: a radio resource control message, a medium access control (MAC) control element, or downlink control information.

Aspect 3: The method of any of Aspects 1 to 2, wherein the reference signal includes a synchronization signal block or a channel state information reference signal.

Aspect 4: The method of any of Aspects 1 to 3, wherein the one or more non-serving cells are associated with a first one or more corresponding physical cell identifiers that differ from a second physical cell identifier of a serving cell of the UE.

Aspect 5: The method of Aspect 4, wherein the serving cell is an activated serving cell or a serving cell for reporting the beam measurement.

Aspect 6: The method of any of Aspects 1 to 5, wherein the codebook information includes at least one of: a beam azimuth angle or spread, a beam elevation angle or spread, a serving cell physical cell identifier, or a non-serving cell physical cell identifier or physical cell identifier group.

Aspect 7: The method of any of Aspects 1 to 6, wherein the antenna location information includes a location configuration for an antenna associated with transmitting the reference signal, wherein the location configuration includes at least one of: a local coordinate system value, or a global coordinate system value.

Aspect 8: The method of any of Aspects 1 to 7, wherein the beam measurement includes a layer-1 reference signal received power or a signal-to-interference-and-noise-ratio.

Aspect 9: The method of any of Aspects 1 to 8, further comprising: determining, based at least in part on the configuration information, a measurement configuration for the beam measurement or a reporting configuration for the beam measurement.

Aspect 10: The method of Aspect 9, further comprising: determining the measurement configuration or the reporting configuration based at least in part on at least one of: a serving cell physical cell identifier, a target non-serving cell physical cell identifier or physical cell identifier group, a layer-1 reference signal received power or a signal-to-interference-and-noise-ratio of the reference signal, an output of a statistical analysis, or an output of an artificial intelligence analysis.

Aspect 11: The method of Aspect 10, wherein the output of the statistical analysis is based at least in part on a set of analytical inputs including a UE location or the configuration information.

Aspect 12: The method of any of Aspects 10 to 11, wherein the output of the artificial intelligence analysis is based at least in part on a set of model inputs or a set of model parameters including a UE location or the configuration information.

Aspect 13: The method of any of Aspects 10 to 11, wherein the artificial intelligence analysis or the statistical analysis is configured based at least in part on radio resource control signaling or is updated based at least in part on medium access control (MAC) control element (CE), or downlink control information, signaling.

Aspect 14: The method of any of Aspects 1 to 11, wherein a radio resource control message includes an information element conveying the configuration information, and wherein the information element is included in at least one of: a channel state information report setting associated with a synchronization signal block resource set for the reference signal for the one or more non-serving cells, a radio resource control configuration for the synchronization signal block resource set, or a radio resource control configuration for a reference signal resource associated with the one or more non-serving cells.

Aspect 15: The method of any of Aspects 1 to 14, wherein a medium access control (MAC) control element or downlink control information includes a field conveying the configuration information, wherein the field is associated with at least one of: overwriting the codebook information, indicating additional codebook information for one or more reference signals, or indicating additional location information for the one or more reference signals.

Aspect 16: A method of wireless communication performed by a network entity, comprising: transmitting configuration information identifying reference signal information for one or more non-serving cells, wherein the reference signal information includes codebook information or antenna location information for a reference signal; and receiving a report of a beam measurement, associated with the reference signal, in accordance with the codebook information or the antenna location information for the reference signal.

Aspect 17: The method of Aspect 16, wherein transmitting the configuration information comprises: transmitting the configuration information via at least one of: a radio resource control message, a medium access control (MAC) control element, or downlink control information.

Aspect 18: The method of any of Aspects 16 to 17, wherein the reference signal includes a synchronization signal block or a channel state information reference signal.

Aspect 19: The method of any of Aspects 16 to 18, wherein the one or more non-serving cells are associated with a first one or more corresponding physical cell identifiers that differ from a second physical cell identifier of a serving cell of the UE.

Aspect 20: The method of Aspect 19, wherein the serving cell is an activated serving cell or a serving cell for reporting the beam measurement.

Aspect 21: The method of any of Aspects 16 to 20, wherein the codebook information includes at least one of: a beam azimuth angle or spread, a beam elevation angle or spread, a serving cell physical cell identifier, or a non-serving cell physical cell identifier or physical cell identifier group.

Aspect 22: The method of any of Aspects 16 to 21, wherein the antenna location information includes a location configuration for an antenna associated with transmitting the reference signal, wherein the location configuration includes at least one of: a local coordinate system value, or a global coordinate system value.

Aspect 23: The method of any of Aspects 16 to 22, wherein the beam measurement includes a layer-1 reference signal received power or a signal-to-interference-and-noise-ratio.

Aspect 24: The method of any of Aspects 16 to 23, wherein a measurement configuration for the beam measurement or a reporting configuration for the beam measurement is based at least in part on the configuration information.

Aspect 25: The method of Aspect 24, wherein the measurement configuration or the reporting configuration is based at least in part on at least one of: a serving cell physical cell identifier, a target non-serving cell physical cell identifier or physical cell identifier group, a layer-1 reference signal received power or a signal-to-interference-and-noise-ratio of the reference signal, an output of a statistical analysis, or an output of an artificial intelligence analysis.

Aspect 26: The method of Aspect 25, wherein the output of the statistical analysis is based at least in part on a set of analytical inputs including a user equipment location or the configuration information.

Aspect 27: The method of any of Aspects 25 to 26, wherein the output of the artificial intelligence analysis is based at least in part on a set of model inputs or a set of model parameters including a user equipment location or the configuration information.

Aspect 28: The method of any of Aspects 25 to 27, wherein the artificial intelligence analysis or the statistical analysis is configured based at least in part on radio resource control signaling or is updated based at least in part on medium access control (MAC) control element (CE), or downlink control information, signaling.

Aspect 29: The method of any of Aspects 16 to 28, wherein a radio resource control message includes an information element conveying the configuration information, and wherein the information element is included in at least one of: a channel state information report setting associated with a synchronization signal block resource set for the reference signal for the one or more non-serving cells, a radio resource control configuration for the synchronization signal block resource set, or a radio resource control configuration for a reference signal resource associated with the one or more non-serving cells.

Aspect 30: The method of any of Aspects 16 to 29, wherein a medium access control (MAC) control element or downlink control information includes a field conveying the configuration information, wherein the field is associated with at least one of: overwriting the codebook information, indicating additional codebook information for one or more reference signals, or indicating additional location information for the one or more reference signals.

Aspect 31: An apparatus for wireless communication at a device, comprising a processor, memory coupled with the processor; and instructions stored in the memory and executable by the processor to cause the apparatus to perform the method of one or more of Aspects 1-15.

Aspect 32: A device for wireless communication, comprising a memory and one or more processors coupled to the memory, the one or more processors configured to perform the method of one or more of Aspects 1-15.

Aspect 33: An apparatus for wireless communication, comprising at least one means for performing the method of one or more of Aspects 1-15.

Aspect 34: A non-transitory computer-readable medium storing code for wireless communication, the code comprising instructions executable by a processor to perform the method of one or more of Aspects 1-15.

Aspect 35: A non-transitory computer-readable medium storing a set of instructions for wireless communication, the set of instructions comprising one or more instructions that, when executed by one or more processors of a device, cause the device to perform the method of one or more of Aspects 1-15.

Aspect 36: An apparatus for wireless communication at a device, comprising a processor; memory coupled with the processor; and instructions stored in the memory and executable by the processor to cause the apparatus to perform the method of one or more of Aspects 16-30.

Aspect 37: A device for wireless communication, comprising a memory and one or more processors coupled to the memory, the one or more processors configured to perform the method of one or more of Aspects 16-30.

Aspect 38: An apparatus for wireless communication, comprising at least one means for performing the method of one or more of Aspects 16-30.

Aspect 39: A non-transitory computer-readable medium storing code for wireless communication, the code comprising instructions executable by a processor to perform the method of one or more of Aspects 16-30.

Aspect 40: A non-transitory computer-readable medium storing a set of instructions for wireless communication, the set of instructions comprising one or more instructions that, when executed by one or more processors of a device, cause the device to perform the method of one or more of Aspects 16-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive configuration information identifying reference signal information for one or more non-serving cells, wherein the reference signal information includes codebook information or antenna location information for a reference signal; and
report a beam measurement associated with the reference signal based at least in part on the codebook information or the antenna location information for the reference signal.

2. The UE of claim 1, wherein the one or more processors, to receive the configuration information, are configured to:
receive the configuration information via at least one of:
a radio resource control message,
a medium access control (MAC) control element, or
downlink control information.

3. The UE of claim 1, wherein the reference signal includes a synchronization signal block or a channel state information reference signal.

4. The UE of claim 1, wherein the one or more non-serving cells are associated with a first one or more corresponding physical cell identifiers that differ from a second physical cell identifier of a serving cell of the UE.

5. The UE of claim 4, wherein the serving cell is an activated serving cell or a serving cell for reporting the beam measurement.

6. The UE of claim 1, wherein the codebook information includes at least one of:
a beam azimuth angle or spread,
a beam elevation angle or spread,
a serving cell physical cell identifier, or
a non-serving cell physical cell identifier or physical cell identifier group.

7. The UE of claim 1, wherein the antenna location information includes a location configuration for an antenna associated with transmitting the reference signal, wherein the location configuration includes at least one of:
a local coordinate system value, or
a global coordinate system value.

8. The UE of claim 1, wherein the beam measurement includes a layer-1 reference signal received power or a signal-to-interference-and-noise-ratio.

9. The UE of claim 1, wherein the one or more processors are further configured to:
determine, based at least in part on the configuration information, a measurement configuration for the beam measurement or a reporting configuration for the beam measurement.

10. The UE of claim 9, wherein the one or more processors are further configured to:
determine the measurement configuration or the reporting configuration based at least in part on at least one of:
a serving cell physical cell identifier,
a target non-serving cell physical cell identifier or physical cell identifier group,
a layer-1 reference signal received power or a signal-to-interference-and-noise-ratio of the reference signal,
an output of a statistical analysis, or
an output of an artificial intelligence analysis.

11. The UE of claim 10, wherein the output of the statistical analysis is based at least in part on a set of analytical inputs including a UE location or the configuration information.

12. The UE of claim 10, wherein the output of the artificial intelligence analysis is based at least in part on a set of model inputs or a set of model parameters including a UE location or the configuration information.

13. The UE of claim 10, wherein the artificial intelligence analysis or the statistical analysis is configured based at least in part on radio resource control signaling or is updated based at least in part on medium access control (MAC) control element (CE), or downlink control information, signaling.

14. The UE of claim 1, wherein a radio resource control message includes an information element conveying the configuration information, and wherein the information element is included in at least one of:
a channel state information report setting associated with a synchronization signal block resource set for the reference signal for the one or more non-serving cells,
a radio resource control configuration for the synchronization signal block resource set, or
a radio resource control configuration for a reference signal resource associated with the one or more non-serving cells.

15. The UE of claim 1, wherein a medium access control (MAC) control element or downlink control information includes a field conveying the configuration information, wherein the field is associated with at least one of:
overwrite the codebook information,
indicate additional codebook information for one or more reference signals, or
indicate additional location information for the one or more reference signals.

16. A network entity for wireless communication, comprising:
a memory; and
one or more processors, coupled to the memory, configured to:
transmit configuration information identifying reference signal information for one or more non-serving cells, wherein the reference signal information includes codebook information or antenna location information for a reference signal; and
receive a report of a beam measurement, associated with the reference signal, in accordance with the codebook information or the antenna location information for the reference signal.

17. The network entity of claim 16, wherein the one or more processors, to transmit the configuration information, are configured to:
transmit the configuration information via at least one of:
a radio resource control message,
a medium access control (MAC) control element, or
downlink control information.

18. The network entity of claim 16, wherein the reference signal includes a synchronization signal block or a channel state information reference signal.

19. The network entity of claim 16, wherein the one or more non-serving cells of a user equipment (UE) are associated with a first one or more corresponding physical cell identifiers that differ from a second physical cell identifier of a serving cell of the UE.

20. The network entity of claim 19, wherein the serving cell is an activated serving cell or a serving cell for reporting the beam measurement.

21. The network entity of claim 16, wherein the codebook information includes at least one of:
a beam azimuth angle or spread,
a beam elevation angle or spread,
a serving cell physical cell identifier, or
a non-serving cell physical cell identifier or physical cell identifier group.

22. The network entity of claim 16, wherein the antenna location information includes a location configuration for an antenna associated with transmitting the reference signal, wherein the location configuration includes at least one of:
a local coordinate system value, or
a global coordinate system value.

23. The network entity of claim 16, wherein the beam measurement includes a layer-1 reference signal received power or a signal-to-interference-and-noise-ratio.

24. The network entity of claim 16, wherein a measurement configuration for the beam measurement or a reporting configuration for the beam measurement is based at least in part on the configuration information.

25. The network entity of claim 24, wherein the measurement configuration or the reporting configuration is based at least in part on at least one of:
a serving cell physical cell identifier,
a target non-serving cell physical cell identifier or physical cell identifier group,
a layer-1 reference signal received power or a signal-to-interference-and-noise-ratio of the reference signal,
an output of a statistical analysis, or
an output of an artificial intelligence analysis.

26. The network entity of claim 25, wherein the output of the statistical analysis is based at least in part on a set of analytical inputs including a user equipment location or the configuration information.

27. The network entity of claim 25, wherein the output of the artificial intelligence analysis is based at least in part on a set of model inputs or a set of model parameters including a user equipment location or the configuration information.

28. The network entity of claim 25, wherein the artificial intelligence analysis or the statistical analysis is configured based at least in part on radio resource control signaling or is updated based at least in part on medium access control (MAC) control element (CE), or downlink control information, signaling.

29. The network entity of claim 16, wherein a radio resource control message includes an information element conveying the configuration information, and wherein the information element is included in at least one of:
a channel state information report setting associated with a synchronization signal block resource set for the reference signal for the one or more non-serving cells,
a radio resource control configuration for the synchronization signal block resource set, or
a radio resource control configuration for a reference signal resource associated with the one or more non-serving cells.

30. The network entity of claim 16, wherein a medium access control (MAC) control element or downlink control information includes a field conveying the configuration information, wherein the field is associated with at least one of:
overwrite the codebook information,
indicate additional codebook information for one or more reference signals, or
indicate additional location information for the one or more reference signals.

31. A method of wireless communication performed by a user equipment (UE), comprising:
receiving configuration information identifying reference signal information for one or more non-serving cells, wherein the reference signal information includes codebook information or antenna location information for a reference signal; and
reporting a beam measurement associated with the reference signal based at least in part on the codebook information or the antenna location information for the reference signal.

32. The method of claim 31, wherein receiving the configuration information comprises:
receiving the configuration information via at least one of:
a radio resource control message,
a medium access control (MAC) control element, or
downlink control information.

33. The method of claim 31, wherein the reference signal includes a synchronization signal block or a channel state information reference signal.

34. A method of wireless communication performed by a network entity, comprising:
transmitting configuration information identifying reference signal information for one or more non-serving cells, wherein the reference signal information includes codebook information or antenna location information for a reference signal; and
receiving a report of a beam measurement, associated with the reference signal, in accordance with the codebook information or the antenna location information for the reference signal.

35. The method of claim 34, wherein transmitting the configuration information comprises:
transmitting the configuration information via at least one of:
a radio resource control message,
a medium access control (MAC) control element, or
downlink control information.
